(19) United States
(12) Patent Application Publication
(10) Pub. No.: US 2026/0303139 A1
(43) Pub. Date: Oct. 1, 2026

(54) RADIO FREQUENCY MODULE AND COMMUNICATION DEVICE

(71) Applicant: Murata Manufacturing Co., Ltd., Nagaokakyo-shi (JP)

(72) Inventor: Daisuke MIYAZAKI, Nagaokakyo-shi (JP)

(73) Assignee: Murata Manufacturing Co., Ltd., Nagaokakyo-shi (JP)

(21) Appl. No.: 19/536,290

(22) Filed: Feb. 11, 2026

(30) Foreign Application Priority Data
Mar. 28, 2025 (JP) 2025-056406

(51) Int. Cl. H04B 1/18; H04B 1/00; H04B 1/40

(52) U.S. Cl. CPC H04B 1/18; H04B 1/0057; H04B 1/006; H04B 1/0064; H04B 1/40

(57) ABSTRACT

A radio frequency module includes first and second low-noise amplifiers, first and second filters, and first to third inductors. A first end of the first inductor is connected to the first low-noise amplifier, while a first end of the second inductor is connected to the second low-noise amplifier. A second end of the second inductor is connected to an output terminal of the second filter. A first end of the third inductor is connected between ground and either the first filter or a switch element. A switching circuitry is configured to selectively connect a second end of the first inductor to the third inductor during a first mode in which the second low-noise amplifier is active and the first low-noise amplifier is inactive.

### CROSS-REFERENCE TO RELATED APPLICATION

This application claims priority to Japanese Patent Application No. 2025-056406, filed on Mar. 28, 2025. The entire contents of that application are incorporated herein by reference.

### BACKGROUND

### 1. Field

The present disclosure relates to a radio frequency module and a communication device.

### 2. Description of the Related Art

International Publication No. 2018/123913 (FIG. 14) discloses a radio frequency module including a low-noise amplifier, first through third reception filters, a switch connected between the low-noise amplifier and the first through third reception filters, a first inductor for impedance matching connected between the first reception filter and the switch, and a second inductor for impedance matching connected between the second reception filter and the switch.

### SUMMARY

According to an aspect of the present disclosure, a radio frequency module includes a first low-noise amplifier and a second low-noise amplifier; a first filter with a pass band including a reception band of a first band; a second filter with a pass band including a reception band of a second band; a first switch circuit including a first terminal and a second terminal; and a first inductor, a second inductor, and a third inductor. A first end of the first inductor is connected to the input terminal of the first low-noise amplifier; a second end of the first inductor is connected to the first terminal; a first end of the second inductor is connected to the input terminal of the second low-noise amplifier; a second end of the second inductor is connected to the output terminal of the second filter; the output terminal of the first filter is connected to the second terminal; a first end of the third inductor is connected to the output terminal of the first filter; a second end of the third inductor is connected to the ground; and the first switch circuit is configured such that the first terminal is connected to the second terminal in a first mode in which the second low-noise amplifier operates and the first low-noise amplifier does not operate.

Also, according to an aspect of the present disclosure, a radio frequency module includes a first low-noise amplifier and a second low-noise amplifier; a first filter with a pass band including a reception band of a first band; a second filter with a pass band including a reception band of a second band; a third filter with a pass band including a reception band of a third band; a first switch circuit including a first terminal, a second terminal, and a third terminal; a first inductor, a second inductor, and a third inductor; and a first switch element. A first end of the first inductor is connected to the input terminal of the first low-noise amplifier; a second end of the first inductor is connected to the first terminal; a first end of the second inductor is connected to the input terminal of the second low-noise amplifier; a second end of the second inductor is connected to the output terminal of the second filter; the output terminal of the first filter is connected to the second terminal; the output terminal of the third filter is connected to the third terminal; a first end of the first switch element is connected to the first terminal; a second end of the first switch element is connected to a first end of the third inductor; and a second end of the third inductor is connected to the ground.

### BRIEF DESCRIPTION OF THE DRAWINGS

FIG. 1 is a circuit diagram of a communication device according to a first embodiment;

FIG. 2 is a diagram for describing a first mode of the radio frequency module according to the first embodiment;

FIG. 3 is a graph showing changes in the Q value of a second inductor resulting from the opening and closing of a first switch circuit;

FIG. 4 is a diagram for describing a second mode of the radio frequency module according to the first embodiment;

FIG. 5 is a circuit diagram of a communication device according to a second embodiment;

FIG. 6 is a diagram for describing a first mode of the radio frequency module according to the second embodiment;

FIG. 7 is a diagram for describing a second mode of the radio frequency module according to the second embodiment; and

FIG. 8 is a schematic plan view illustrating a component layout of the radio frequency module according to the first embodiment.

### DETAILED DESCRIPTION

Embodiments are described in detail below with reference to the drawings. Each of the embodiments described below represents a general or specific example. Values, shapes, materials, components, and layouts and connection configurations of the components described in the embodiments below are just examples and are not intended to limit the present disclosure.

Each of the drawings is a schematic diagram in which components are emphasized or omitted and the ratios between the components are adjusted to facilitate the understanding of the present disclosure. That is, components in each of the drawings are not necessarily illustrated accurately; and the shapes, positional relationships, and ratios of the components may differ from the actual shapes, positional relationships, and ratios. The same reference number is assigned to substantially the same components in the drawings, and repeated descriptions of those components may be omitted or simplified.

In the drawings described below, the x-axis and the y-axis are orthogonal to each other on a plane that is parallel to the major surface of a mounting board. The z-axis is perpendicular to the major surface of the mounting board, the positive z-axis direction indicates the upward direction, and the negative z-axis direction indicates the downward direction.

In the descriptions below, “connected” not only indicates that circuit elements are directly connected to each other with a connection terminal and/or a wire conductor but also indicates that the circuit elements are electrically connected to each other via another circuit element. “C is connected between A and B” indicates that one end of C is connected to A, the other end of C is connected to B, and C is disposed in series in a path between A and B. “Path between A and B” indicates a path formed by a conductor that electrically connects A to B. “Pass band of a filter” indicates a portion of a frequency spectrum that is passed by the filter and is defined as a frequency band between two frequencies at which the power insertion loss is 3 dB greater than the minimum power insertion loss.

“Transmission band” refers to a frequency band used for transmission in a communication device, and “reception band” refers to a frequency band used for reception in a communication device. For example, in a frequency division duplex (FDD) band, different frequency bands (uplink band and downlink band) are used as the transmission band and the reception band. Also, for example, in a TDD band, the same frequency band is used as the transmission band and the reception band.

“Terminal” indicates a point at which a conductor in an element ends. Here, when the impedance of a conductor between elements is sufficiently low, a terminal is interpreted not only as a single point but also as any point on the conductor between the elements or the entire conductor.

Also, “a component is disposed on a substrate” may indicate that the component is disposed on the major surface of the substrate or the component is disposed in the substrate. “A component is disposed on the major surface of a substrate” indicates not only a case in which the component is disposed in contact with the major surface of the substrate but also a case in which the component is disposed above the major surface and not in contact with the major surface (e.g., the component is stacked on another component that is disposed in contact with the major surface).

In the component layout of the present disclosure, “winding axis directions are aligned” not only indicates that the angle between two winding axes is 0°, but also indicates that two winding axis directions are substantially aligned with each other. For example, “winding axis directions are aligned” may indicate that the angle (smaller angle) between the two winding axes is within 30°.

### Embodiments

The inventor has determined that, with the radio frequency module of International Publication No. 2018/123913, if the spacing between the first inductor and the second inductor cannot be ensured due to the miniaturization requirement, the mutual interference between the first inductor and the second inductor increases, resulting in degradation of reception sensitivity.

For the above reason, the present disclosure is directed to providing a radio frequency module and a communication device that can suppress the degradation of reception sensitivity.

In view of the above and other problems, a radio frequency module includes a first low-noise amplifier and a second low-noise amplifier. The module further includes a first filter with a pass band including a reception band of a first band, and a second filter with a pass band including a reception band of a second band. A first inductor has a first end connected to the input terminal of the first low-noise amplifier, and a second inductor has a first end connected to the input terminal of the second low-noise amplifier and a second end connected to the output terminal of the second filter.

Furthermore, the radio frequency module includes a third inductor having a first end connected to the output terminal of the first filter and a second end connected to the ground. Switching circuitry is configured to selectively connect a second end of the first inductor to the first end of the third inductor in a first mode in which the second low-noise amplifier is active and the first low-noise amplifier is inactive.

### 1. Configuration of Communication Device 4

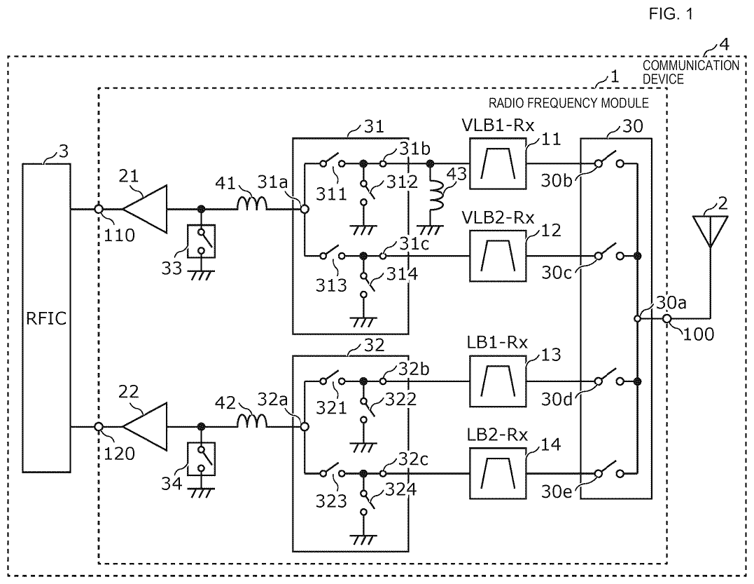

First, a configuration of a communication device 4 according to an embodiment is described with reference to FIG. 1. FIG. 1 is a circuit diagram of the communication device 4 according to the first embodiment.

Here, FIG. 1 illustrates an exemplary configuration, and the communication device 4 may be implemented by using any of various types of circuit implementation and circuit technologies. Therefore, the following descriptions of the communication device 4 should not be interpreted restrictively. The functionality of the elements disclosed herein (e.g., the control unit) may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any.

The communication device 4 may be used to provide wireless connection. For example, the communication device 4 may be used for UEs, such as a mobile phone, a smartphone, a tablet computer, and a wearable device, in a cellular network (also referred to as a mobile network). As another example, the communication device 4 may be used to provide wireless connection for Internet of Things (IoT) sensor devices, medical/healthcare devices, vehicles, unmanned aerial vehicles (UAV) (commonly known as drones), and automated guided vehicles (AGV). As still another example, the communication device 4 may be used to provide wireless connection at wireless access points or wireless hotspots.

The communication device 4 includes a radio frequency module 1, an antenna 2, and a radio frequency integrated circuit (RFIC) 3.

The radio frequency module 1 can transmit radio frequency signals between the antenna 2 and the RFIC 3. Details of the circuit configuration of the radio frequency module 1 are described later.

The antenna 2 is connected to the radio frequency module 1, can receive radio frequency signals from outside the communication device 4, and can supply the received radio frequency signals to the radio frequency module 1. A part or the entirety of the antenna 2 does not have to be included in the communication device 4. Also, the communication device 4 may include one or more antennas in addition to the antenna 2.

The RFIC 3 is an example of a signal processing circuit that processes radio frequency signals. Specifically, the RFIC 3 can perform signal processing, such as down-converting, on a radio frequency reception signal input via the radio frequency module 1 and output a reception signal generated by the signal processing to a baseband integrated circuit (BBIC). Furthermore, the RFIC 3 may include a control unit that controls switches and amplifiers included in the radio frequency module 1. Some or all of the functions of the control unit of the RFIC 3 may be provided outside the RFIC 3 and may be included in, for example, the BBIC or the radio frequency module 1.

### 2. Circuit Configuration of Radio Frequency Module 1

As illustrated in FIG. 1, the radio frequency module 1 includes low-noise amplifiers 21 and 22, filters 11, 12, 13, and 14, switch circuits 30, 31, and 32, switch elements 33 and 34, inductors 41, 42, and 43, an antenna connection terminal 100, and radio frequency output terminals 110 and 120.

The antenna connection terminal 100 is an external connection terminal of the radio frequency module 1 and receives radio frequency signals from the antenna 2. The antenna connection terminal 100 is connected to the antenna 2 outside the radio frequency module 1 and is connected to the switch circuit 30 inside the radio frequency module 1.

The radio frequency output terminals 110 and 120 are external connection terminals of the radio frequency module 1 that supply radio frequency signals to the RFIC 3. The radio frequency output terminals 110 and 120 are connected to the RFIC 3 outside the radio frequency module 1 and are connected, respectively, to the low-noise amplifiers 21 and 22 inside the radio frequency module 1.

The low-noise amplifier 21 is an example of a first low-noise amplifier and can amplify, for example, signals in a very low band group (600 MHz-850 MHz). The input terminal of the low-noise amplifier 21 is connected to a first end of the inductor 41, and the output terminal of the low-noise amplifier 21 is connected to the radio frequency output terminal 110.

The low-noise amplifier 22 is an example of a second low-noise amplifier and can amplify, for example, signals in a low band group (850 MHz-1 GHz). The input terminal of the low-noise amplifier 22 is connected to a first end of the inductor 42, and the output terminal of the low-noise amplifier 22 is connected to the radio frequency output terminal 120.

The filter 11 is an example of a first filter and is, for example, a band pass filter with a pass band that includes a reception band (VLB1-Rx) of a band VLB1 belonging to the very low band group. The filter 11 can pass signals in the reception band of the band VLB1 and can attenuate signals outside the reception band of the band VLB1. The input terminal of the filter 11 is connected to a selection terminal 30b of the switch circuit 30, and the output terminal of the filter 11 is connected to a selection terminal 31b of the switch circuit 31. The filter 11 includes an acoustic wave resonator. The acoustic wave resonator included in the filter 11 may be, for example, a surface acoustic wave (SAW) resonator or a bulk acoustic wave (BAW) resonator. The SAW includes not only a surface wave but also a boundary wave.

The filter 12 is an example of a third filter and is, for example, a band pass filter with a pass band that includes a reception band (VLB2-Rx) of a band VLB2 belonging to the very low band group. The filter 12 can pass signals in the reception band of the band VLB2 and can attenuate signals outside the reception band of the band VLB2. The input terminal of the filter 12 is connected to a selection terminal 30c of the switch circuit 30, and the output terminal of the filter 12 is connected to a selection terminal 31c of the switch circuit 31.

The filter 13 is an example of a second filter and is, for example, a band pass filter with a pass band that includes a reception band (LB1-Rx) of a band LB1 belonging to the low band group. The filter 13 can pass signals in the reception band of the band LB1 and can attenuate signals outside the reception band of the band LB1. The input terminal of the filter 13 is connected to a selection terminal 30d of the switch circuit 30, and the output terminal of the filter 13 is connected to a selection terminal 32b of the switch circuit 32.

The filter 14 is an example of a fourth filter and is, for example, a band pass filter with a pass band that includes a reception band (LB2-Rx) of a band LB2 belonging to the low band group. The filter 14 can pass signals in the reception band of the band LB2 and can attenuate signals outside the reception band of the band LB2. The input terminal of the filter 14 is connected to a selection terminal 30e of the switch circuit 30, and the output terminal of the filter 14 is connected to a selection terminal 32c of the switch circuit 32.

The bands VLB1 and VLB2 are located on the lower frequency side relative to the bands LB1 and LB2.

Each of the filters 12 through 14 may be any type of filter, such as a SAW filter with a SAW resonator, a BAW filter with a BAW resonator, an LC filter, or a dielectric filter.

Also, the filters 11 through 14 are not limited to band pass filters. Some or all of the filters 11 through 14 may be band elimination filters, high pass filters, low pass filters, or any combination of these filters.

The switch circuit 31 is an example of a first switch circuit and is a Single-Pole Double-Throw (SPDT) switch circuit including a common terminal 31a (first terminal), the selection terminal 31b (second terminal), and the selection terminal 31c (third terminal). The switch circuit 31 is disposed between the inductor 41 and the filters 11 and 12, connects and disconnects the inductor 41 to and from the filter 11, and connects and disconnects the inductor 41 to and from the filter 12.

Specifically, the switch circuit 31 includes Single-Pole Single-Throw (SPST) switch elements 311, 312, 313, and 314. The switch element 311 is a series switch connected between the common terminal 31a and the selection terminal 31b, and the switch element 312 is a shunt switch connected between the selection terminal 31b and the ground. The switch element 313 is a series switch connected between the common terminal 31a and the selection terminal 31c, and the switch element 314 is a shunt switch connected between the selection terminal 31c and the ground. The switch elements 311 and 312 are alternately switched between conductive and non-conductive states in an exclusive manner. This improves the isolation between the common terminal 31a, the selection terminal 31b, and the ground. The switch elements 313 and 314 are alternately switched between conductive and non-conductive states in an exclusive manner. This improves the isolation between the common terminal 31a, the selection terminal 31c, and the ground.

The switch circuit 32 is an example of a third switch circuit and is an SPDT switch circuit including a common terminal 32a (second common terminal), the selection terminal 32b (third selection terminal), and the selection terminal 32c (fourth selection terminal). The switch circuit 32 is disposed between the inductor 42 and the filters 13 and 14, connects and disconnects the inductor 42 to and from the filter 13, and connects and disconnects the inductor 42 to and from the filter 14.

Specifically, the switch circuit 32 includes SPST switch elements 321, 322, 323, and 324. The switch element 321 is a series switch connected between the common terminal 32a and the selection terminal 32b, and the switch element 322 is a shunt switch connected between the selection terminal 32b and the ground. The switch element 323 is a series switch connected between the common terminal 32a and the selection terminal 32c, and the switch element 324 is a shunt switch connected between the selection terminal 32c and the ground. The switch elements 321 and 322 are alternately switched between conductive and non-conductive states in an exclusive manner. This improves the isolation between the common terminal 32a, the selection terminal 32b, and the ground. The switch elements 323 and 324 are alternately switched between conductive and non-conductive states in an exclusive manner. This improves the isolation between the common terminal 32a, the selection terminal 32c, and the ground.

The switch circuit 30 is an example of a second switch circuit and is a Single-Pole 4-Throw (SP4T) switch circuit including a common terminal 30a (first common terminal), the selection terminal 30b (first selection terminal), the selection terminal 30c, the selection terminal 30d (second selection terminal), and the selection terminal 30e. The switch circuit 30 is disposed between the antenna connection terminal 100 and the filters 11 through 14, connects and disconnects the antenna connection terminal 100 to and from the filter 11, connects and disconnects the antenna connection terminal 100 to and from the filter 12, connects and disconnects the antenna connection terminal 100 to and from the filter 13, and connects and disconnects the antenna connection terminal 100 to and from the filter 14.

The switch element 33 is an example of a second switch element and is connected between the input terminal of the low-noise amplifier 21 and the ground. The switch element 33 is set to the conductive state when the low-noise amplifier 21 is deactivated.

The switch element 34 is connected between the input terminal of the low-noise amplifier 22 and the ground. The switch element 34 is set to the conductive state when the low-noise amplifier 22 is deactivated.

The inductor 41 is an example of a first inductor. A first end of the inductor 41 is connected to the input terminal of the low-noise amplifier 21, and a second end of the inductor 41 is connected to the common terminal 31a. The inductor 41 is an element for achieving impedance matching between the filters 11 and 12 and the low-noise amplifier 21, and may be referred to as a “first matching inductor”.

The inductor 42 is an example of a second inductor. A first end of the inductor 42 is connected to the input terminal of the low-noise amplifier 22, and a second end of the inductor 42 is connected to the common terminal 32a and is therefore connected to the output terminal of the filter 13 and the output terminal of the filter 14 via the switch circuit 32. The inductor 42 is an element for achieving impedance matching between the filters 13 and 14 and the low-noise amplifier 22, and may be referred to as a “second matching inductor”.

The inductor 43 is an example of a third inductor. A first end of the inductor 43 is connected to the output terminal of the filter 11, and a second end of the inductor 43 is connected to the ground. The inductor 43 is an element for achieving impedance matching between the filter 11 and the low-noise amplifier 21 and for increasing the pass band width of the filter 11, and may be referred to as a “shunting inductor”.

At least one of the filters 12 and 14, the switch circuits 30 and 32, and the switch elements 33 and 34 does not have to be included in the radio frequency module 1.

### 3. Frequency Bands Supported by Radio Frequency Module 1

The bands VLB1, VLB2, LB1, and LB2 supported by the radio frequency module 1 are described.

The bands VLB1, VLB2, LB1, and LB2 are frequency bands for a communication system that is constructed using a radio access technology (RAT). The bands VLB1, VLB2, LB1, and LB2 are predefined by, for example, standardizing bodies (e.g., 3GPP (registered trademark) and IEEE). Examples of communication systems include 5th Generation New Radio (5G NR) systems, 4th Generation Long Term Evolution (4G LTE) systems, Second Generation Global System for Mobile Communications (2G GSM) systems, and Wireless Local Area Network (WLAN) systems.

The band VLB1 is an example of a first band and is a frequency division duplex (FDD) band, a time division duplex (TDD) band, or a supplementary uplink (SUL) band. The band VLB2 is an example of a third band and is an FDD band, a TDD band, or an SUL band. Each of the bands VLB1 and VLB2 may be selected from LTE Band 29, Band 20, Band 28, Band 12, Band 13, or Band 14, or 5G NR n29, n20, n28, n12, n13, n14, or n105. However, each of the bands VLB1 and VLB2 is not limited to these bands.

The band LB1 is an example of a second band and is an FDD band, a TDD band, or an SUL band. The band LB2 is an example of a fourth band and is an FDD band, a TDD band, or an SUL band. Each of the bands LB1 and LB2 may be selected from LTE Band 8 or Band 26, or 5G NR n8 or n26. However, each of the bands LB1 and LB2 is not limited to these bands.

The bands VLB1 and LB1 constitute a band combination that is not used for simultaneous communication.

### 4. Communication Modes of Radio Frequency Module 1

Next, communication modes of the radio frequency module 1 are described.

### 4.1. First Mode

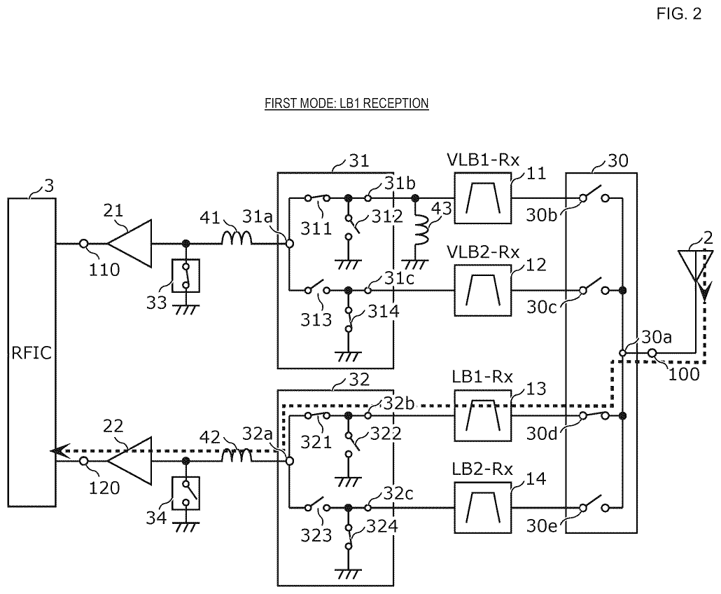

A first mode of the radio frequency module 1 is described with reference to FIG. 2. FIG. 2 is a diagram for describing the first mode of the radio frequency module 1 according to the first embodiment. In FIG. 2, a dashed arrow represents a signal path.

The first mode is a communication mode in which signals in the band LB1 are received, signals in the band LB2 are not received, and signals in the bands VLB1 and VLB2 are not received. Alternatively, signals in the band LB2 may be received in the first mode. In other words, the first mode is a communication mode in which the low-noise amplifier 22 operates and the low-noise amplifier 21 does not operate.

In the first mode of the radio frequency module 1, the common terminal 32a is connected to the selection terminal 32b (the switch element 321 is in the conductive state), the common terminal 32a is not connected to the selection terminal 32c (the switch element 323 is in the non-conductive state), the common terminal 30a is connected to the selection terminal 30d, the common terminal 30a is not connected to the selection terminal 30e, and the switch element 34 is in the non-conductive state. Also, in the first mode, the switch element 322 is in the non-conductive state, and the switch element 324 is in the conductive state.

Also, in the first mode, the common terminal 31a is connected to the selection terminal 31b (the switch element 311 is in the conductive state), the common terminal 31a is not connected to the selection terminal 31c (the switch element 313 is in the non-conductive state), the common terminal 30a is not connected to the selection terminal 30b, the common terminal 30a is not connected to the selection terminal 30c, and the switch element 33 is in the conductive state. Also, in the first mode, the switch element 312 is in the non-conductive state, and the switch element 314 is in the conductive state.

Alternatively, in the first mode, instead of setting the switch element 33 to the conductive state, the supply of a bias current (voltage) to the low-noise amplifier 21 may be stopped and/or the supply of a power supply voltage to the low-noise amplifier 21 may be stopped.

In this mode, a reception signal in the band LB1 is transmitted from the antenna 2 to the RFIC 3 via the antenna connection terminal 100, the switch circuit 30, the filter 13, the switch circuit 32, the inductor 42, the low-noise amplifier 22, and the radio frequency output terminal 120.

Here, the distance between the inductor 41 and the inductor 42 decreases as the size of the radio frequency module 1 decreases. As a result, the inductor 41 and the inductor 42 interfere with each other, and parasitic capacitance is generated between the inductor 41 and the inductor 42. Consequently, a series connection circuit constituted by the parasitic capacitance and the inductor 41 is connected between the ground and the signal path for the band LB1 that connects the filter 13, the switch circuit 32, the inductor 42, and the low-noise amplifier 22. The series connection circuit functions as a notch circuit that has a resonance point in a given frequency band. When the given frequency band is in the vicinity of the band LB1, the Q value of the inductor 42 in a frequency band including the band LB1 degrades, the signal quality of reception signals passing through the signal path for the band LB1 decreases, and the reception sensitivity of the radio frequency module 1 for signals in the band LB1 decreases.

For this reason, in the first mode of the radio frequency module 1 according to the present embodiment, the switch element 311 is set to the conductive state even though no signal in the band VLB1 is flowing through the signal path for the band VLB1 connecting the filter 11, the switch circuit 31, the inductor 41, and the low-noise amplifier 21. As a result, the second end of the inductor 41 is connected to the ground via the inductor 43. This means that the parasitic capacitance described above is connected to the inductor 41 via the ground. Accordingly, the series connection circuit (notch circuit) as described above is not generated, and degradation of the Q value of the inductor 42 can be suppressed.

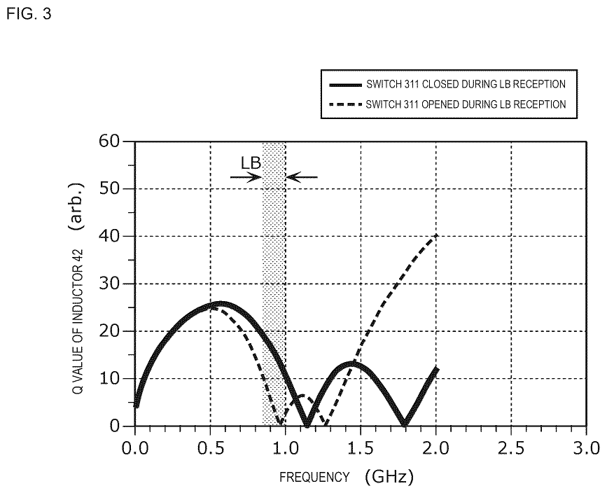

FIG. 3 is a graph showing changes in the Q value of the inductor 42 resulting from the opening and closing of the switch circuit 31. As shown in FIG. 3, when the switch element 311 is in the non-conductive state, the minimum Q value of the inductor 42 is included in the low band group, and the Q value of the inductor 42 in the band LB1 is relatively small. On the other hand, when the switch element 311 is in the conductive state, the minimum Q value of the inductor 42 is not included in the low band group, and the Q value of the inductor 42 in the band LB1 is relatively large. Thus, when the switch element 311 is in the conductive state, the degradation of the Q value of the inductor 42 is suppressed. This makes it possible to suppress the degradation of the signal quality of reception signals passing through the signal path for the band LB1 and to suppress the degradation of the reception sensitivity of the radio frequency module 1 for signals in the band LB1.

When the inductor 43, which is connected between the output terminal of the filter 11 and the ground, is connected to the inductor 41, the generation of the notch circuit can be prevented, the pass band of the filter 11 including an acoustic wave resonator can be widened, and the signal transmission loss of signals in the band VLB1 can be reduced.

Furthermore, because the inductor 43 is connected to the ground, it is possible to protect the filter 11 from electrostatic discharge (ESD).

Also, an inductor may be connected between the output terminal of the filter 12 and the ground. In this case, in the first mode, the switch element 313 may be set to the conductive state instead of setting the switch element 311 to the conductive state. Furthermore, in the first mode, instead of setting the switch element 311 to the conductive state, both of the switch elements 311 and 313 may be set to the conductive state. In this case, because the parasitic capacitance described above is connected to the inductor 41 via the ground, the notch circuit as described above is not generated, and the degradation of the Q value of the inductor 42 can be suppressed.

### 4.2. Second Mode

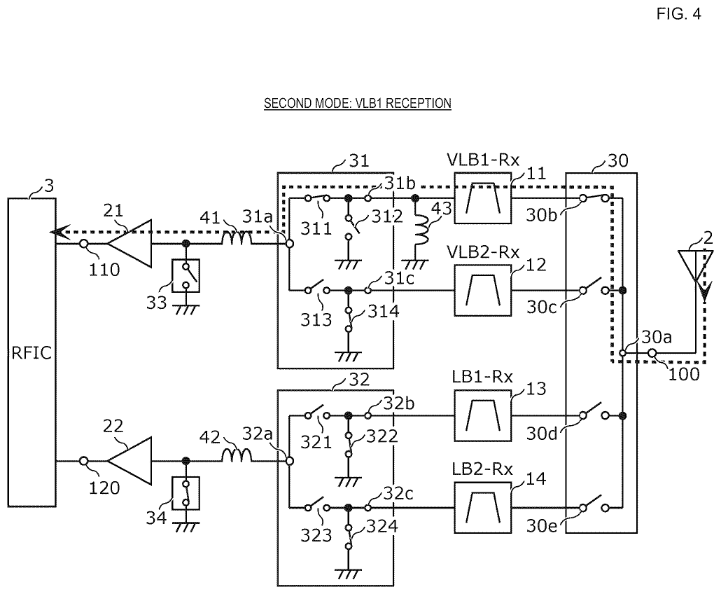

A second mode of the radio frequency module 1 is described with reference to FIG. 4. FIG. 4 is a diagram for describing the second mode of the radio frequency module 1 according to the first embodiment. In FIG. 4, a dashed arrow represents a signal path.

The second mode is a communication mode in which signals in the band VLB1 are received, signals in the band VLB2 are not received, and signals in the bands LB1 and LB2 are not received. Alternatively, signals in the band VLB2 may be received in the second mode. In other words, the second mode is a communication mode in which the low-noise amplifier 21 operates and the low-noise amplifier 22 does not operate.

In the second mode of the radio frequency module 1, the common terminal 31a is connected to the selection terminal 31b (the switch element 311 is in the conductive state), the common terminal 31a is not connected to the selection terminal 31c (the switch element 313 is in the non-conductive state), the common terminal 30a is connected to the selection terminal 30b, the common terminal 30a is not connected to the selection terminal 30c, and the switch element 33 is in the non-conductive state. Also, in the second mode, the switch element 312 is in the non-conductive state, and the switch element 314 is in the conductive state.

Also, in the second mode, the common terminal 32a is not connected to the selection terminal 32b (the switch element 321 is in the non-conductive state), the common terminal 32a is not connected to the selection terminal 32c (the switch element 323 is in the non-conductive state), the common terminal 30a is not connected to the selection terminal 30d, the common terminal 30a is not connected to the selection terminal 30e, and the switch element 34 is in the conductive state. Also, in the second mode, the switch element 322 is in the conductive state, and the switch element 324 is in the conductive state.

Alternatively, in the second mode, instead of setting the switch element 34 to the conductive state, the supply of a bias current (voltage) to the low-noise amplifier 22 may be stopped and/or the supply of a power supply voltage to the low-noise amplifier 22 may be stopped.

In this mode, a reception signal in the band VLB1 is transmitted from the antenna 2 to the RFIC 3 via the antenna connection terminal 100, the switch circuit 30, the filter 11, the switch circuit 31, the inductor 41, the low-noise amplifier 21, and the radio frequency output terminal 110.

Here, the inductor 43 connected between the output terminal of the filter 11 and the ground is connected to the inductor 41. This makes it possible to prevent the generation of the notch circuit in the first mode and makes it possible to widen the pass band of the filter 11 including the acoustic wave resonator in the second mode. This in turn makes it possible to reduce the signal transmission loss of signals in the band VLB1 in the second mode.

Furthermore, because the inductor 43 is connected to the ground, it is possible to protect the filter 11 from electrostatic discharge (ESD).

An inductor may also be provided between the output terminal of the filter 13 and the ground and/or between the output terminal of the filter 14 and the ground. In this case, in the second mode, the switch element 321 or 323 is set to the conductive state even though no signal in the band LB1 is flowing through the signal path for the band LB1. As a result, the second end of the inductor 42 is connected to the ground. In this case, because the parasitic capacitance to be connected to the inductor 41 is connected to the inductor 42 via the ground, the degradation of the Q value of the inductor 41 in the VLB1 band can be suppressed.

Here, an inductor to be connected between the output terminal of any of the filters 11 through 14 and the ground may be connected between the output terminal of the filter 11 or 12 and the ground rather than between the output terminal of the filter 13 or 14 and the ground.

The minimum Q value of an inductor caused by the notch circuit connected to a signal path is more likely to appear at higher frequencies. Therefore, the degradation of the Q value caused by the notch circuit can be more effectively suppressed in a case in which signals in the low band group are transmitted than in a case in which signals in the very low band group are transmitted.

### 5. Configuration of Communication Device 6 according to a Second Embodiment

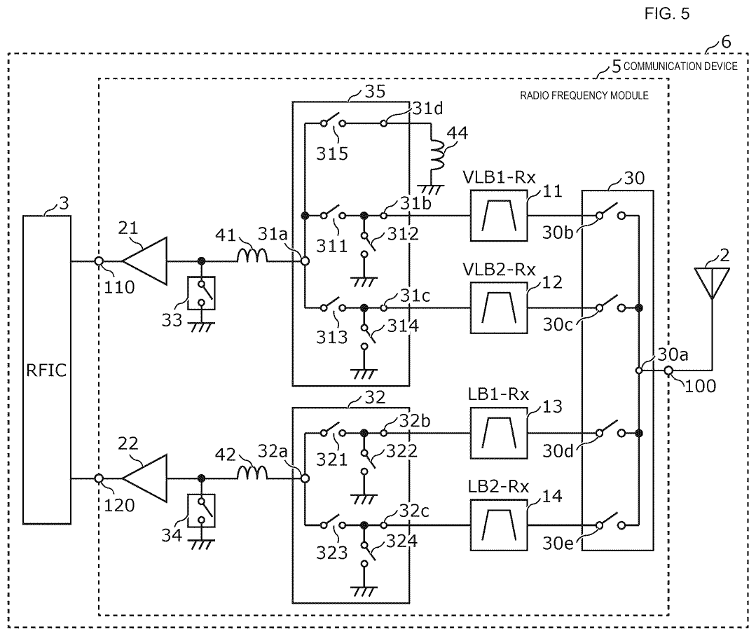

A configuration of a communication device 6 according to a second embodiment is described with reference to FIG. 5. FIG. 5 is a circuit diagram of the communication device 6 according to the second embodiment.

Here, FIG. 5 illustrates an exemplary configuration, and the communication device 6 may be implemented by using any of various types of circuit implementation and circuit technologies. Therefore, the following descriptions of the communication device 6 should not be interpreted restrictively.

The communication device 6 includes a radio frequency module 5, an antenna 2, and an RFIC 3. The communication device 6 according to the second embodiment differs from the communication device 4 according to the first embodiment only in that the communication device 6 includes the radio frequency module 5 instead of the radio frequency module 1. Therefore, descriptions of components of the communication device 6 of the second embodiment that are the same as those of the communication device 4 are omitted, and the radio frequency module 5, which is different from the radio frequency module 1 of the communication device 4, is described below.

The radio frequency module 5 can transmit radio frequency signals between the antenna 2 and the RFIC 3.

### 6. Circuit Configuration of Radio Frequency Module 5

As illustrated in FIG. 5, the radio frequency module 5 includes low-noise amplifiers 21 and 22, filters 11, 12, 13, and 14, switch circuits 30, 35, and 32, switch elements 33 and 34, inductors 41, 42, and 44, an antenna connection terminal 100, and radio frequency output terminals 110 and 120. The radio frequency module 5 of the second embodiment differs from the radio frequency module 1 of the first embodiment in that the radio frequency module 5 includes the switch circuit 35 and the inductor 44 instead of the switch circuit 31 and the inductor 43. Below, regarding the radio frequency module 5 of the second embodiment, descriptions of configurations that are the same as those of the radio frequency module 1 are not repeated, and configurations different from those of the radio frequency module 1 are mainly described.

The filter 11 is an example of a first filter and is, for example, a band pass filter with a pass band that includes a reception band (VLB1-Rx) of a band VLB1 belonging to the very low band group. The input terminal of the filter 11 is connected to a selection terminal 30b of the switch circuit 30, and the output terminal of the filter 11 is connected to a selection terminal 31b of the switch circuit 35.

The filter 12 is an example of a third filter and is, for example, a band pass filter with a pass band that includes a reception band (VLB2-Rx) of a band VLB2 belonging to the very low band group. The input terminal of the filter 12 is connected to a selection terminal 30c of the switch circuit 30, and the output terminal of the filter 12 is connected to a selection terminal 31c of the switch circuit 35.

The filter 13 is an example of a second filter and is, for example, a band pass filter with a pass band that includes a reception band (LB1-Rx) of a band LB1 belonging to the low band group. The input terminal of the filter 13 is connected to a selection terminal 30d of the switch circuit 30, and the output terminal of the filter 13 is connected to a selection terminal 32b of the switch circuit 32.

The filter 14 is an example of a fourth filter and is, for example, a band pass filter with a pass band that includes a reception band (LB2-Rx) of a band LB2 belonging to the low band group. The input terminal of the filter 14 is connected to a selection terminal 30e of the switch circuit 30, and the output terminal of the filter 14 is connected to a selection terminal 32c of the switch circuit 32.

The switch circuit 35 is an example of a first switch circuit and is a Single-Pole 3-Throw (an SP3T) switch circuit including a common terminal 31a (first terminal), the selection terminal 31b (second terminal), the selection terminal 31c (third terminal), and a selection terminal 31d (fourth terminal). The switch circuit 35 is disposed between the inductor 41 and a combination of the filters 11 and 12 and the inductor 44, connects and disconnects the inductor 41 to and from the filter 11, connects and disconnects the inductor 41 to and from the filter 12, and connects and disconnects the inductor 41 to and from the inductor 44.

Specifically, the switch circuit 35 includes SPST switch elements 311, 312, 313, 314, and 315. The switch element 311 is a series switch connected between the common terminal 31a and the selection terminal 31b, and the switch element 312 is a shunt switch connected between the selection terminal 31b and the ground. The switch element 313 is a series switch connected between the common terminal 31a and the selection terminal 31c, and the switch element 314 is a shunt switch connected between the selection terminal 31c and the ground. The switch element 315 is an example of a first switch element and is a series switch connected between the common terminal 31a and the selection terminal 31d. A first end of the switch element 315 is connected to the common terminal 31a, and a second end of the switch element 315 is connected to a first end of the inductor 44. The switch elements 311 and 312 are alternately switched between conductive and non-conductive states in an exclusive manner. This improves the isolation between the common terminal 31a, the selection terminal 31b, and the ground. The switch elements 313 and 314 are alternately switched between conductive and non-conductive states in an exclusive manner. This improves the isolation between the common terminal 31a, the selection terminal 31c, and the ground. The switch elements 312 and 314 may be omitted.

The inductor 44 is an example of a third inductor. A first end of the inductor 44 is connected to the second end of the switch element 315, and a second end of the inductor 44 is connected to the ground. The inductor 44 is an element for achieving impedance matching between the filters 11 and 12 and the low-noise amplifier 21 and for increasing the pass band width of each of the filters 11 and 12.

None of the filters, the switch circuit 30, and the antenna connection terminal 100 is connected to the selection terminal 31d of the switch circuit 35.

At least one of the filter 14, the switch circuits 30 and 32, and the switch elements 33 and 34 does not have to be included in the radio frequency module 5.

The switch element 315 does not have to be included in the switch circuit 35. In this case, the first end of the switch element 315 is connected to a node on a path between the second end of the inductor 41 and the common terminal 31a, the second end of the switch element 315 is connected to the first end of the inductor 44, and the second end of the inductor 44 is connected to the ground.

### 7. Communication Modes of Radio Frequency Module 5

Next, communication modes of the radio frequency module 5 are described.

### 7.1. First Mode

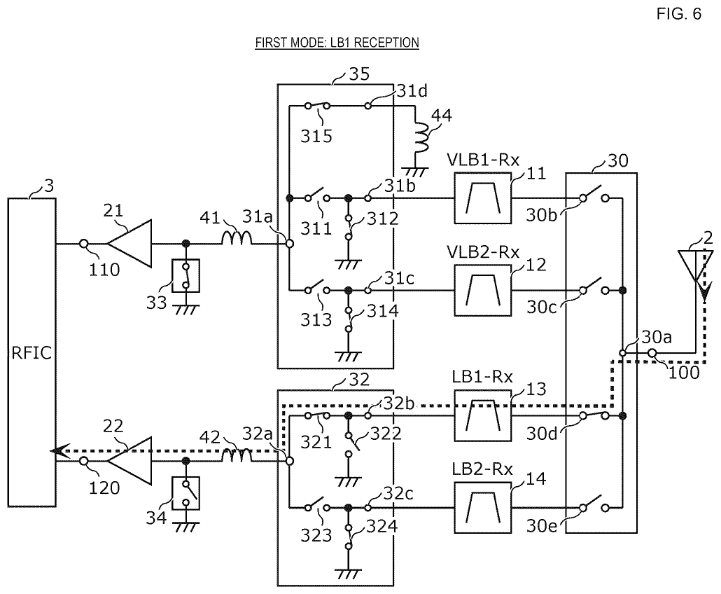

A first mode of the radio frequency module 5 is described with reference to FIG. 6. FIG. 6 is a diagram for describing the first mode of the radio frequency module 5 according to the second embodiment. In FIG. 6, a dashed arrow represents a signal path.

The first mode is a communication mode in which signals in the band LB1 are received, signals in the band LB2 are not received, and signals in the bands VLB1 and VLB2 are not received. Alternatively, signals in the band LB2 may be received in the first mode. In other words, the first mode is a communication mode in which the low-noise amplifier 22 operates and the low-noise amplifier 21 does not operate.

In the first mode of the radio frequency module 5, the common terminal 32a is connected to the selection terminal 32b (the switch element 321 is in the conductive state), the common terminal 32a is not connected to the selection terminal 32c (the switch element 323 is in the non-conductive state), the common terminal 30a is connected to the selection terminal 30d, the common terminal 30a is not connected to the selection terminal 30e, and the switch element 34 is in the non-conductive state. Also, in the first mode, the switch element 322 is in the non-conductive state, and the switch element 324 is in the conductive state.

Also, in the first mode, the switch element 315 is in the conductive state, the common terminal 31a is not connected to the selection terminal 31b (the switch element 311 is in the non-conductive state), the common terminal 31a is not connected to the selection terminal 31c (the switch element 313 is in the non-conductive state), the common terminal 30a is not connected to the selection terminal 30b, the common terminal 30a is not connected to the selection terminal 30c, and the switch element 33 is in the conductive state. Also, in the first mode, the switch element 312 is in the conductive state, and the switch element 314 is in the conductive state.

Alternatively, in the first mode, instead of setting the switch element 33 to the conductive state, the supply of a bias current (voltage) to the low-noise amplifier 21 may be stopped and/or the supply of a power supply voltage to the low-noise amplifier 21 may be stopped.

In this mode, a reception signal in the band LB1 is transmitted from the antenna 2 to the RFIC 3 via the antenna connection terminal 100, the switch circuit 30, the filter 13, the switch circuit 32, the inductor 42, the low-noise amplifier 22, and the radio frequency output terminal 120.

Here, the distance between the inductor 41 and the inductor 42 decreases as the size of the radio frequency module 5 decreases. As a result, the inductor 41 and the inductor 42 interfere with each other, and parasitic capacitance is generated between the inductor 41 and the inductor 42. Consequently, a series connection circuit constituted by the parasitic capacitance and the inductor 41 is connected between the ground and the signal path for the band LB1 that connects the filter 13, the switch circuit 32, the inductor 42, and the low-noise amplifier 22. The series connection circuit functions as a notch circuit that has a resonance point in a given frequency band. When the given frequency band is in the vicinity of the band LB1, the Q value of the inductor 42 in a frequency band including the band LB1 degrades, the signal quality of reception signals passing through the signal path for the band LB1 decreases, and the reception sensitivity of the radio frequency module 5 for signals in the band LB1 decreases.

For this reason, in the first mode of the radio frequency module 5 according to the second embodiment, the switch element 315 is set to the conductive state even though no signal in the band VLB1 is flowing through the signal path for the band VLB1 connecting the filter 11, the switch circuit 35, the inductor 41, and the low-noise amplifier 21. As a result, the second end of the inductor 41 is connected to the ground via the inductor 44. This means that the parasitic capacitance described above is connected to the inductor 41 via the ground. Accordingly, the notch circuit as described above is not generated, and degradation of the Q value of the inductor 42 can be suppressed. This makes it possible to suppress the degradation of the signal quality of reception signals passing through the signal path for the band LB1 and to suppress the degradation of the reception sensitivity of the radio frequency module 5 for signals in the band LB1.

When the inductor 44, which is connected between the common terminal 31a and the ground, is connected to the inductor 41, the generation of the notch circuit can be prevented, the pass band of each of the filters 11 and 12 including an acoustic wave resonator can be widened, and the signal transmission loss of signals in the bands VLB1 and VLB2 can be reduced.

### 7.2. Second Mode

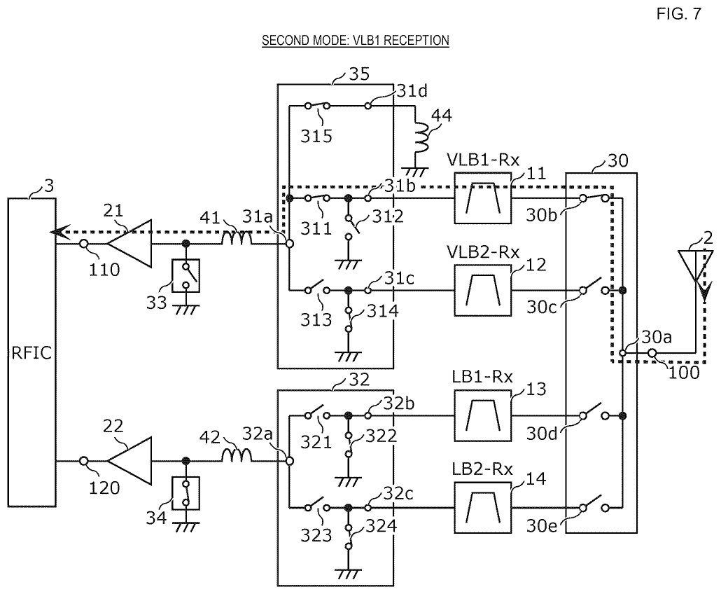

A second mode of the radio frequency module 5 is described with reference to FIG. 7. FIG. 7 is a diagram for describing the second mode of the radio frequency module 5 according to the second embodiment. In FIG. 7, a dashed arrow represents a signal path.

The second mode is a communication mode in which signals in the band VLB1 are received, signals in the band VLB2 are not received, and signals in the bands LB1 and LB2 are not received. Alternatively, signals in the band VLB2 may be received in the second mode. In other words, the second mode is a communication mode in which the low-noise amplifier 21 operates and the low-noise amplifier 22 does not operate.

In the second mode of the radio frequency module 5, the common terminal 31a is connected to the selection terminal 31b (the switch element 311 is in the conductive state), the common terminal 31a is connected to the selection terminal 31d (the switch element 315 is in the conductive state), the common terminal 31a is not connected to the selection terminal 31c (the switch element 313 is in the non-conductive state), the common terminal 30a is connected to the selection terminal 30b, the common terminal 30a is not connected to the selection terminal 30c, and the switch element 33 is in the non-conductive state. Also, in the second mode, the switch element 312 is in the non-conductive state, and the switch element 314 is in the conductive state.

Also, in the second mode, the common terminal 32a is not connected to the selection terminal 32b (the switch element 321 is in the non-conductive state), the common terminal 32a is not connected to the selection terminal 32c (the switch element 323 is in the non-conductive state), the common terminal 30a is not connected to the selection terminal 30d, the common terminal 30a is not connected to the selection terminal 30e, and the switch element 34 is in the conductive state. Also, in the second mode, the switch element 322 is in the conductive state, and the switch element 324 is in the conductive state.

Alternatively, in the second mode, instead of setting the switch element 34 to the conductive state, the supply of a bias current (voltage) to the low-noise amplifier 22 may be stopped and/or the supply of a power supply voltage to the low-noise amplifier 22 may be stopped.

In this mode, a reception signal in the band VLB1 is transmitted from the antenna 2 to the RFIC 3 via the antenna connection terminal 100, the switch circuit 30, the filter 11, the switch circuit 35, the inductor 41, the low-noise amplifier 21, and the radio frequency output terminal 110.

Here, the inductor 44 connected between the common terminal 31a and the ground is connected to the inductor 41. This makes it possible to prevent the generation of the notch circuit in the first mode and makes it possible to widen the pass band of the filter 11 including the acoustic wave resonator in the second mode. This in turn makes it possible to reduce the signal transmission loss of signals in the band VLB1 in the second mode.

In the second mode, the switch element 315 may be in the non-conductive state. In this case, the pass band of the filter 11 is not widened in the second mode.

Furthermore, because the inductor 44 is connected to the ground, it is possible to protect the filter 11 from electrostatic discharge (ESD).

A series connection circuit constituted by a switch element and an inductor may be connected between the common terminal 32a and the ground. In this case, in the second mode, the switch element is set to the conductive state even when no signal in the band LB1 is flowing through the signal path for the band LB1. As a result, the second end of the inductor 42 is connected to the ground. Consequently, the parasitic capacitance to be connected to the inductor 41 is connected to the inductor 42 via the ground, and therefore the degradation of the Q value of the inductor 41 in the VLB1 band can be suppressed.

The series connection circuit constituted by the switch element and the inductor may be connected between the common terminal 31a and the ground rather than between the common terminal 32a and the ground.

The minimum Q value of an inductor caused by the notch circuit connected to a signal path is more likely to appear at higher frequencies. Therefore, the degradation of the Q value caused by the notch circuit can be more effectively suppressed in a case in which signals in the low band group are transmitted than in a case in which signals in the very low band group are transmitted.

### 8. Component Layout of Radio Frequency Module 1

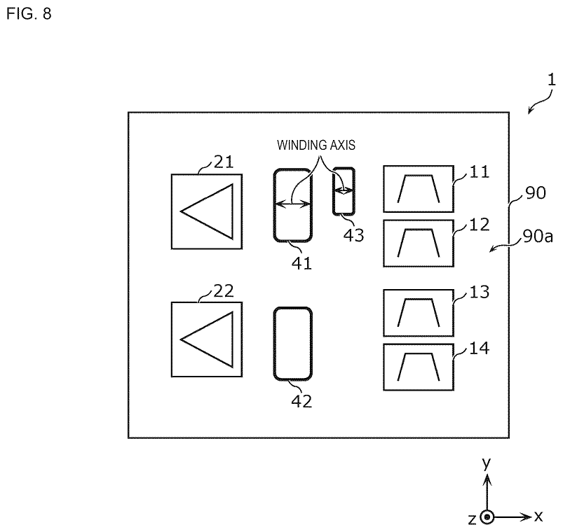

A component layout of the radio frequency module 1 according to the first embodiment is described with reference to FIG. 8. FIG. 8 is a schematic plan view illustrating a component layout of the radio frequency module 1 according to the first embodiment.

FIG. 8 illustrates the layout of some of circuit components when a major surface 90a of a mounting board 90 is seen from the positive z-axis direction. Also, although marks indicating functions are provided for filters in FIG. 8 to facilitate the understanding of the layout of the filters, the marks are not provided for actual filters.

The radio frequency module 1 illustrated in FIG. 8 includes the mounting board 90 in addition to the components of the radio frequency module 1 illustrated in FIG. 1.

The mounting board 90 has the major surface 90a. Wires and via conductors are formed in the mounting board 90 and/or on the mounting board 90. The mounting board 90 may be implemented by, for example, a substrate made of a ceramic base body (LTCC: low temperature co-fired ceramics) formed by co-firing a multilayer body including multiple dielectric layers at a low temperature, a substrate made of a ceramic base body (HTCC: high temperature co-fired ceramics) formed by co-firing a multilayer body at a high temperature, a component-embedded board, a substrate including a redistribution layer (RDL), or a printed circuit board. However, the mounting board 90 is not limited to these examples.

As illustrated in FIG. 8, the low-noise amplifiers 21 and 22, the filters 11 through 14, and the inductors 41 through 43 are disposed on the major surface 90a. At least one of the low-noise amplifiers 21 and 22, the filters 11 through 14, and the inductors 41 through 43 may be disposed on a major surface on the opposite side of the major surface 90a. The switch circuits 30 through 32, the switch elements 33 and 34, the antenna connection terminal 100, and the radio frequency output terminals 110 and 120 may also be disposed on the mounting board 90.

Each of the inductors 41 through 43 is a surface-mounted chip inductor. At least one of the inductors 41 through 43 may be implemented by a coil conductor formed on the mounting board 90.

As illustrated in FIG. 8, the winding axis direction of the inductor 41 is aligned with the winding axis direction of the inductor 43.

This makes it possible to facilitate the magnetic field coupling between the inductor 41 and the inductor 43 and thereby makes it possible to reduce the inductance value inherent to the inductor 41 compared with a case in which the inductor 41 is not magnetically coupled to the inductor 43. This in turn makes it possible to reduce the resistance value of the inductor 41 and thereby makes it possible to reduce the transmission loss of signals transmitted through the signal paths for the bands VLB1 and VLB2.

### [9. Effects]

As described above, the radio frequency module 1 according to the present embodiment includes the low-noise amplifiers 21 and 22, the filter 11 with a pass band including the reception band of the band VLB1, the filter 13 with a pass band including the reception band of the band LB1, the switch circuit 31 including the common terminal 31a and the selection terminal 31b, and the inductors 41 through 43. A first end of the inductor 41 is connected to the input terminal of the low-noise amplifier 21, a second end of the inductor 41 is connected to the common terminal 31a, a first end of the inductor 42 is connected to the input terminal of the low-noise amplifier 22, a second end of the inductor 42 is connected to the output terminal of the filter 13, the output terminal of the filter 11 is connected to the selection terminal 31b, a first end of the inductor 43 is connected to the output terminal of the filter 11, a second end of the inductor 43 is connected to the ground, and the switch circuit 31 is configured such that the common terminal 31a is connected to the selection terminal 31b in the first mode in which the low-noise amplifier 22 operates and the low-noise amplifier 21 does not operate.

With the above configuration, in the first mode, the second end of the inductor 41 is connected to the ground via the inductor 43. This makes it possible to prevent the generation of the notch circuit constituted by the parasitic capacitance and the inductor 41 and thereby makes it possible to suppress the degradation of the Q value of the inductor 42. This in turn makes it possible to suppress the degradation of the signal quality of reception signals passing through the signal paths for the bands LB1 and LB2 and to suppress the degradation of the reception sensitivity of the radio frequency module 1 for signals in the bands LB1 and LB2.

For example, the radio frequency module 1 further includes the switch circuit 30 including the common terminal 30a and the selection terminals 30b and 30d, the common terminal 30a is connected to the antenna connection terminal 100, the input terminal of the filter 11 is connected to the selection terminal 30b, and the input terminal of the filter 13 is connected to the selection terminal 30d. In the first mode, the common terminal 31a is connected to the selection terminal 31b, the common terminal 30a is not connected to the selection terminal 30b, and the common terminal 30a is connected to the selection terminal 30d.

With this configuration, in the first mode, the inductor 43 and the ground can be used as a means to suppress the degradation of the quality of signals in the bands LB1 and LB2 in a state in which the filter 11 and the inductor 43 are not connected to the antenna connection terminal 100.

Also, for example, the radio frequency module 1 further includes the filter 12 with a pass band including the reception band of the band VLB2, the switch circuit 31 further includes the selection terminal 31c, the output terminal of the filter 12 is connected to the selection terminal 31c. In the first mode, the common terminal 31a is connected to the selection terminal 31b, and the common terminal 31a is not connected to the selection terminal 31c.

This makes it possible to enhance the grounding of the second end of the inductor 41 in the first mode.

Also, for example, the radio frequency module 1 further includes the filter 14 with a pass band including the reception band of the band LB2 and the switch circuit 32 including the common terminal 32a and the selection terminals 32b and 32c. The second end of the inductor 42 is connected to the output terminal of the filter 13 via the switch circuit 32, the common terminal 32a is connected to the second end of the inductor 42, the selection terminal 32b is connected to the output terminal of the filter 13, and the selection terminal 32c is connected to the output terminal of the filter 14. The switch circuit 32 is configured such that in the first mode, the common terminal 32a is connected to the selection terminal 32b or 32c; and in the second mode in which the low-noise amplifier 21 operates and the low-noise amplifier 22 does not operate, the common terminal 31a is connected to the selection terminal 31b or 31c and the common terminal 32a is not connected to the selection terminals 32b and 32c.

This configuration makes it possible to connect the filter 13 or 14 to the low-noise amplifier 22 in the first mode and to disconnect the filters 13 and 14 from the low-noise amplifier 22 in the second mode.

The radio frequency module 5 according to the second embodiment includes the low-noise amplifiers 21 and 22, the filter 11 with a pass band including the reception band of the band VLB1, the filter 13 with a pass band including the reception band of the band LB1, the filter 12 with a pass band including the reception band of the band VLB2, the switch circuit 35 including the common terminal 31a and the selection terminals 31b and 31c, the inductors 41, 42, and 44, and the switch element 315. A first end of the inductor 41 is connected to the input terminal of the low-noise amplifier 21, a second end of the inductor 41 is connected to the common terminal 31a, a first end of the inductor 42 is connected to the input terminal of the low-noise amplifier 22, a second end of the inductor 42 is connected to the output terminal of the filter 13, the output terminal of the filter 11 is connected to the selection terminal 31b, the output terminal of the filter 12 is connected to the selection terminal 31c, a first end of the switch element 315 is connected to the common terminal 31a, a second end of the switch element 315 is connected to a first end of the inductor 44, and a second end of the inductor 44 is connected to the ground.

This makes it possible to connect the second end of the inductor 41 to the ground via the inductor 44. Thus, in the first mode in which signals in the band LB1 or LB2 are transmitted, connecting the second end of the inductor 41 to the ground makes it possible to disable the notch circuit that is constituted by the parasitic capacitance and the inductor 41 and is possibly connected to the inductor 42. This makes it possible to suppress the degradation of the Q value of the inductor 42 in the first mode. This in turn makes it possible to suppress the degradation of the signal quality of reception signals passing through the signal paths for the bands LB1 and LB2 and to suppress the degradation of the reception sensitivity of the radio frequency module 5 for signals in the bands LB1 and LB2.

Also, for example, in the radio frequency module 5, the switch circuit 35 further includes the selection terminal 31d and the switch element 315, a first end of the switch element 315 is connected to the common terminal 31a, a second end of the switch element 315 is connected to the selection terminal 31d, and no filter is connected to the selection terminal 31d.

With this configuration, in the first mode, the second end of the inductor 41 is connected to the ground via the switch circuit 35 and the inductor 44. This makes it possible to prevent the generation of the notch circuit constituted by the parasitic capacitance and the inductor 41 and thereby makes it possible to suppress the degradation of the Q value of the inductor 42. This in turn makes it possible to suppress the degradation of the signal quality of reception signals passing through the signal paths for the bands LB1 and LB2 and to suppress the degradation of the reception sensitivity of the radio frequency module 5 for signals in the bands LB1 and LB2.

Also, for example, in the radio frequency module 5, the switch element 315 is set to the conductive state in the first mode in which the low-noise amplifier 22 operates and the low-noise amplifier 21 does not operate.

With this configuration, in the first mode, because the second end of the inductor 41 is connected to the ground via the switch element 315 and the inductor 44, the notch circuit constituted by the parasitic capacitance and the inductor 41 is not generated, and the degradation of the Q value of the inductor 42 can be suppressed. This in turn makes it possible to suppress the degradation of the signal quality of reception signals passing through the signal paths for the bands LB1 and LB2 and to suppress the degradation of the reception sensitivity of the radio frequency module 5 for signals in the bands LB1 and LB2.

For example, the radio frequency module 5 further includes the switch circuit 30 including the common terminal 30a and the selection terminals 30b and 30d, the common terminal 30a is connected to the antenna connection terminal 100, the input terminal of the filter 11 is connected to the selection terminal 30b, and the input terminal of the filter 13 is connected to the selection terminal 30d. In the first mode, the switch element 315 is set to the conductive state, the common terminal 30a is not connected to the selection terminal 30b, and the common terminal 30a is connected to the selection terminal 30d.

With this configuration, in the first mode, the inductor 44 and the ground can be used as a means to suppress the degradation of the quality of signals in the bands LB1 and LB2 in a state in which the filter 11 is not connected to the antenna connection terminal 100.

Also, for example, the radio frequency module 5 further includes the filter 14 with a pass band including the reception band of the band LB2 and the switch circuit 32 including the common terminal 32a and the selection terminals 32b and 32c. The second end of the inductor 42 is connected to the output terminal of the filter 13 via the switch circuit 32, the common terminal 32a is connected to the second end of the inductor 42, the selection terminal 32b is connected to the output terminal of the filter 13, and the selection terminal 32c is connected to the output terminal of the filter 14. The switch circuit 32 is configured such that in the first mode, the common terminal 32a is connected to the selection terminal 32b or 32c; and in the second mode in which the low-noise amplifier 21 operates and the low-noise amplifier 22 does not operate, the common terminal 31a is connected to the selection terminal 31b or 31c and the common terminal 32a is not connected to the selection terminals 32b and 32c.

This configuration makes it possible to connect the filter 13 or 14 to the low-noise amplifier 22 in the first mode and to disconnect the filters 13 and 14 from the low-noise amplifier 22 in the second mode.

Also, for example, each of the radio frequency modules 1 and 5 further includes the switch element 33 connected between the input terminal of the low-noise amplifier 21 and the ground, and the switch element 33 is set to the conductive state in the first mode.

This makes it possible to prevent reception signals in the bands VLB1 and VLB2 from being input to the low-noise amplifier 21 and to deactivate the low-noise amplifier 21 for the reception signals.

Also, for example, in each of the radio frequency modules 1 and 5, the filter 11 includes an acoustic wave resonator.

With this configuration, because the inductor 43 (or the inductor 44) is shunt-connected to the output terminal of the filter 11, the pass band of the filter 11 can be widened.

Also, for example, in the radio frequency modules 1 and 5, the band VLB1 is located on the lower frequency side relative to the band LB1.

The minimum Q value of an inductor caused by the notch circuit connected to a signal path is more likely to appear at higher frequencies. Therefore, the degradation of the Q value caused by the notch circuit can be more effectively suppressed in a case in which signals in the low band group (LB1 and LB2) are transmitted than in a case in which signals in the very low band group (VLB1 and VLB2) are transmitted.

Also, for example, in the radio frequency modules 1 and 5, the band VLB1 belongs to the very low band group (600 MHz-850 MHz), and the band LB1 belongs to the low band group (850 MHz-1 GHz).

This makes it possible to use the radio frequency modules 1 and 5 for LTE systems and/or 5G NR systems.

Also, for example, in the radio frequency module 1 (5), the winding axis direction of the inductor 41 is aligned with the winding axis direction of the inductor 43 (44).

This makes it possible to facilitate the magnetic field coupling between the inductor 41 and the inductor 43 (44) and thereby makes it possible to reduce the inductance value inherent to the inductor 41 compared with a case in which the inductor 41 is not magnetically coupled to the inductor 43 (44). This in turn makes it possible to reduce the resistance value of the inductor 41 and thereby makes it possible to reduce the transmission loss of signals transmitted through the signal paths for the bands VLB1 and VLB2.

Also, the communication device 4 according to the present embodiment (and the communication device 6 according to the second embodiment) includes the RFIC 3 configured to process radio frequency signals and the radio frequency module 1 (5) configured to transmit the radio frequency signals between the RFIC 3 and the antenna 2.

With this configuration, the communication device 4 (6) can achieve effects that are substantially the same as those achieved by the radio frequency module 1 (5).

The above embodiments provide several technical effects. First, by connecting the second end of the first inductor to ground via the third inductor in the first mode, generation of a notch circuit that would otherwise be formed by parasitic capacitance between the first and second inductors may be suppressed. Second, the shunting mechanism suppresses the degradation of the Q value of the second inductor in the frequency band including the second band. Third, by maintaining the Q value, the radio frequency module suppresses degradation of signal quality and reception sensitivity for signals in the second band. Fourth, the shunt connection of the third inductor can widen the pass band of filters using acoustic wave resonators and provides protection against electrostatic discharge (ESD).

### Other Embodiments

Radio frequency modules and communication devices according to first and second embodiments of the present disclosure are described above. However, radio frequency modules and communication devices according to the present disclosure are not limited to those described herein. Other embodiments implemented by combining components in the above embodiment and variation, variations obtained by applying various modifications conceivable by a person skilled in the art to the above embodiment and variation without departing from the spirit of the present disclosure, and various devices including the radio frequency modules described above are also included in the present disclosure.

For example, in the circuit configurations of the radio frequency modules according to the above embodiment and variation, additional circuit elements and wires may be inserted in paths connecting the circuit elements and the signal paths illustrated in the drawings.

The present disclosure can be widely used for communication devices, such as mobile phones, as a radio frequency module disposed in a front-end unit.

What is claimed is:

1. A radio frequency module comprising:
a first low-noise amplifier and a second low-noise amplifier;
a first filter with a pass band including a reception band of a first band;
a second filter with a pass band including a reception band of a second band;
a first inductor having a first end connected to an input terminal of the first low-noise amplifier;
a second inductor having a first end connected to an input terminal of the second low-noise amplifier and a second end connected to an output terminal of the second filter;
a third inductor having a first end connected to the output terminal of a ground; and
switching circuitry configured to selectively connect a second end of the first inductor to a first end of the third inductor in a first mode in which the second low-noise amplifier is active and the first low-noise amplifier is inactive.

2. The radio frequency module according to claim 1, wherein the switching circuitry comprises:
a first switch circuit including a first terminal and a second terminal, wherein
the second end of the first inductor is connected to the first terminal,
an output terminal of the first filter is connected to the second terminal and to the first end of the third inductor, and
the first switch circuit is configured to connect the first terminal to the second terminal in the first mode.

3. The radio frequency module according to claim 2, further comprising:
a third filter with a pass band including a reception band of a third band, wherein
the first switch circuit further includes a third terminal;
an output terminal of the third filter is connected to the third terminal; and
in the first mode, the first terminal is connected to the second terminal, and the first terminal is not connected to the third terminal.

4. The radio frequency module according to claim 3, further comprising:
a fourth filter with a pass band including a reception band of a fourth band; and
a third switch circuit including a second common terminal, a third selection terminal, and a fourth selection terminal, wherein
the second end of the second inductor is connected to the output terminal of the second filter via the third switch circuit;
the second common terminal is connected to the second end of the second inductor;
the third selection terminal is connected to the output terminal of the second filter;
the fourth selection terminal is connected to an output terminal of the fourth filter; and
the third switch circuit is configured such that
in the first mode, the second common terminal is connected to the third selection terminal or the fourth selection terminal, and
in a second mode in which the first low-noise amplifier is active and the second low-noise amplifier is not active, the first terminal is connected to the second terminal or the third terminal, and the second common terminal is not connected to the third selection terminal and the fourth selection terminal.

5. The radio frequency module according to claim 4, wherein the third switch circuit is configured such that:
in the first mode, the second common terminal is connected to the third selection terminal or the fourth selection terminal; and
in the second mode, the first terminal is connected to the second terminal or the third terminal, and the second common terminal is disconnected from the third selection terminal and the fourth selection terminal.

6. The radio frequency module according to claim 1, further comprising:
a second switch circuit including a first common terminal, a first selection terminal, and a second selection terminal, wherein
the first common terminal is connected to the antenna connection terminal,
an input terminal of the first filter is connected to the first selection terminal,
an input terminal of the second filter is connected to the second selection terminal; and
in the first mode, the first terminal is connected to the second terminal, the first common terminal is not connected to the first selection terminal, and the first common terminal is connected to the second selection terminal.

7. The radio frequency module according to claim 1, further comprising:
a third filter with a pass band including a reception band of a third band, wherein the switching circuitry includes
a first switch circuit including a first terminal, a second terminal, and a third terminal; and
a first switch element, wherein
a second end of the first inductor is connected to the first terminal;
an output terminal of the first filter is connected to the second terminal;
an output terminal of the third filter is connected to the third terminal;
a first end of the first switch element is connected to the first terminal;
a second end of the first switch element is connected to a first end of the third inductor; and
a second end of the third inductor is connected to a ground.

8. The radio frequency module according to claim 7, wherein
the first switch circuit further includes a fourth terminal and the first switch element;
the first end of the first switch element is connected to the first terminal;
the second end of the first switch element is connected to the fourth terminal; and
no filter is connected to the fourth terminal.

9. The radio frequency module according to claim 7, wherein
in the first mode, the first switch element is in a conductive state.

10. The radio frequency module according to claim 9, further comprising:
a second switch circuit including a first common terminal, a first selection terminal, and a second selection terminal, wherein
the first common terminal is connected to the antenna connection terminal;
an input terminal of the first filter is connected to the first selection terminal;
an input terminal of the second filter is connected to the second selection terminal; and
in the first mode, the first switch element is in a conductive state, the first common terminal is not connected to the first selection terminal, and the first common terminal is connected to the second selection terminal.

11. The radio frequency module according to claim 9, further comprising:
a fourth filter with a pass band including a reception band of a fourth band; and
a third switch circuit including a second common terminal, a third selection terminal, and a fourth selection terminal, wherein
the second end of the second inductor is connected to the output terminal of the second filter via the third switch circuit;
the second common terminal is connected to the second end of the second inductor;
the third selection terminal is connected to the output terminal of the second filter;
the fourth selection terminal is connected to the output terminal of the fourth filter; and
the third switch circuit is configured such that
in the first mode, the second common terminal is connected to the third selection terminal or the fourth selection terminal, and
in a second mode in which the first low-noise amplifier is active and the second low-noise amplifier is not active, the first terminal is connected to the second terminal or the third terminal, and the second common terminal is not connected to the third selection terminal and the fourth selection terminal.

12. The radio frequency module according to claim 7, further comprising:
a second switch element connected between the input terminal of the first low-noise amplifier and the ground, wherein
in the first mode, the second switch element is in a conductive state.

13. The radio frequency module according to of Claim 1, wherein
the first filter includes an acoustic wave resonator.

14. The radio frequency module according to claim 1, wherein
the first band is located on a lower frequency side relative to the second band.

15. The radio frequency module according to claim 14, wherein
the first band belongs to a very low band group (600 MHz-850 MHz); and
the second band belongs to a low band group (850 MHz-1 GHz).

16. The radio frequency module according to claim 1, wherein
a winding axis direction of the first inductor is aligned with a winding axis direction of the third inductor.

17. The radio frequency module according to claim 1, wherein the first switch circuitry further includes a shunt switch connected between the second terminal and the ground.

18. The radio frequency module according to claim 1, wherein the switching circuitry includes a switch element connected between the input terminal of the first low-noise amplifier and the ground, the second switch element being in a conductive state in the first mode.

19. A communication device comprising:
a signal processing circuit configured to process a radio frequency signal; and
the radio frequency module according to claim 1 configured to transmit the radio frequency signal between the signal processing circuit and the antenna.

20. A radio frequency module, comprising:
first and second low-noise amplifiers;
a first signal path including a first matching inductor and a first filter;
a second signal path including a second matching inductor and a second filter; and
switching circuitry configured to shunt the first matching inductor to ground through a shunt inductor during a first mode where the second signal path is active and the first signal path is inactive.
